(19) United States
(12) Patent Application Publication
(10) Pub. No.: US 2004/0119577 A1
(43) Pub. Date: Jun. 24, 2004

(54) Coil arrangement with variable inductance

(76) Inventor: Robert Weger, Augsburg (DE)

Correspondence Address: DUANE MORRIS LLP, Suite 700, 1667 K Street, N.W., Washington, DC, 20006, US

(21) Appl. No.: 10/720,485

(22) Filed: Nov. 25, 2003

(30) Foreign Application Priority Data
Dec. 20, 2002 (DE) 102 60 246.8

(51) Int. Cl. H01F 27/28

(52) U.S. Cl. 336/229

(57) ABSTRACT

The invention relates to a coil arrangement with variable inductance having two separate toroid coils which carry working windings, and a control winding encompassing the two wound toroid coils for the purpose of pre-magnetizing the core material of the toroid coils.

The invention relates to a coil arrangement whose inductance can be varied by a control current.

Coil arrangements with variable inductance are used in power engineering and telecommunications applications. One such use of coils with variable inductance is in the area of switching power supplies in order to adapt the energy transfer taking place in the high-frequency range to changing load requirements.

The earliest means of varying the inductance of a coil was by mechanically changing the position of an iron core, or a ferrite core, in the coil. Such a change in the inductance of a coil was made, for example, for a one-time alignment of an oscillating circuit. However, as soon as the variable inductance of the coil is to be used as an element in a control loop, it must be possible to vary the inductance of the coil as fast as possible by means of an electric signal. To realize such electrically controlled inductance, the effect in which the relative magnetic permeability of ferro and ferromagnetic materials decreases together with the magnetic flux density in the material can be employed. Based on this principle, numerous coil arrangements have been proposed in the past which, by means of a current in a control coil, cause a magnetically highly permeable coil core to be pre-magnetized and in this way control the inductance of the working winding, also positioned on the coil core.

One of the first publications on this is U.S. Pat. No. 2,229,952 from Whiteley and Ludbrook with the title “Magnetic Amplifier” dated 1941. The coil described here features an EE core which carries a control winding on its center leg and working windings on its outer legs. A DC current flows through the control winding thereby generating a magnetic flux in the EE core which is distributed to all three legs. The core material is pre-magnetized by the current flowing through the control winding. By means of this pre-magnetization, the effective permeability of the core material is changed and thus also the inductance of the working windings.

With an increasing control current and the resulting decreasing permeability, the magnetic flux flow characteristics deteriorate for the high-frequency flux in the outer legs generated by the outer windings so that strong electromagnetic interference emissions are produced especially in the areas of low inductance.

A disadvantage of these and similar arrangements known from the prior art lies in the fact that the AC voltage established at the working windings is transmitted to the control coil which results in a deterioration of the electrical characteristics of the arrangement. Added to this is the fact that in many applications, the control coil has a much greater number of turns than the working coils, which goes to intensify the problem.

This disadvantage is known in the prior art and attempts have been made to overcome it. In British Patent Application GB 2 195 850 A1 it was suggested to connect a capacitor in parallel to the control winding. To avoid this problem, in U.S. Pat. No. 6,317,021 it was suggested that a parallel connection of working windings be provided. The first method has the disadvantage of additional losses due to a short-circuit current in the control winding. In the solution offered by U.S. Pat. No. 6,317,021, the working windings are connected in such a way that the magnetic fluxes for the control winding generated by these windings cancel each other out. The flux cancellation (flux annihilation) in the control winding, however, only appears when the magnetic conductance in the outer legs and the center leg for both sides of the EE core is the same. However, the parasitic air gaps on the faces of the two halves of the EE core—an unavoidable result of the manufacturing process—are often the cause of asymmetries in magnetic conductance. In accordance with U.S. Pat. No. 6,317,021, an appropriate cross-sectional relationship between the core legs for the working and control coils determines whether the center leg is also saturated thus effecting a change in inductance in the control coil as well. To avoid the center leg, which carries the control winding, being more quickly saturated than the outer legs when the saturation current increases, the US patent suggests that the center leg has a cross-section which is at least double as large as the cross-sections of each of the outer legs.

A major disadvantage of all arrangements based on EE cores lies in the fact that for high saturation degrees a significant proportion of the magnetic field of the working coils leaves the now low permeable core and EMC-related interference fields are created. This is particularly the case for applications with very strong high-frequency currents in the working windings, for example, when the controllable inductance is used as a reactive multiplier to regulate the output in switching power supplies.

Another basic problem in using EE cores is created by the unavoidable parasitic air gaps at the contact surfaces of the two halves of the core. These create different magnetic conductances for the flux line channels through the two working windings and thus different premagnetizations. This results on the one hand in significant tolerances for the adjustable inductance range of the coil configuration, on the other hand, inductance differences between the windings of the working coils appear. The latter means that the coil configuration conducts the positive and negative half-waves of the signal differently at the working coils.

It is therefore the object of the invention to provide a coil arrangement with variable inductance which has a large control range and generates low electromagnetic interference, whereby the heat loss of the coil arrangement is to be kept low. These characteristics are particularly relevant for switching power supplies with high power density.

This object has been achieved by a coil arrangement with the characteristics as outlined in claim 1.

The invention provides a coil arrangement with variable inductance having two separate toroid coils which carry working windings, as well as a control winding which encompasses the two wound toroid coils in order to pre-magnetize the core material of the toroid coils. In accordance with the invention, due to the cylindrical symmetry of the toroids and the preferably even distribution of the working windings around the circumference of the toroids, the strength of the magnetic field outside the windings is reduced considerably and this independent of the permeability of the core.

In the prior art, electromagnetic interference fields of controlled inductances mostly appear when the magnetic permeability of the core material has become low due to premagnetization since it is then that the magnet field of the coil runs increasingly outside the coil. Additionally, when permeability is low, coil impedance is low and the coil current especially large. By providing evenly wound toroid coils, the interference fields outside the core can, however, be largely avoided.

Since the arrangement of the present invention does not have any parasitic air gaps in the field line channel, their associated tolerance and asymmetry problems do not occur. In addition, the increased magnetic conductance, due to the non-existence of air gaps, enables improved control of the core or a greater achievable inductance range. Moreover, the cost of manufacturing two toroids is less than the cost for two halves of an E core. Since according to the invention, the working windings encompass the entire core and not just the outer part of the legs, this results in a larger winding width compared to the prior art. This means that more copper per layer can be accommodated resulting in lower energy losses in the working windings.

In particular, through the present invention, toroids can be employed whose symmetry and constant cross-sections give them optimal magnetic properties. Unwanted stray fields are reduced to a minimum and the rotational symmetry ensures that all areas of the core is premagnetized to the same extent. The cores can be stacked along their rotational axis without forfeiting their electrical characteristics which enables a compact construction with good cooling properties.

In accordance with the invention, the coil arrangement consists of at least two closed toroid coils. The toroid form was chosen because here the magnetic saturation of the core material can be achieved in a particularly beneficial manner. Rotationally symmetric toroids are superior to the conventional EE cores known in the prior art in terms of EMC-related interference and the utilization of winding space. Any round toroids available on the market can be used, whereby the toroids preferably have a rectangular base cross-section.

In accordance with the invention, the coil arrangement preferably includes two toroid coils which are either arranged so that their axes of symmetry are in line or that they lie next to each other in a common plane.

In a coaxial arrangement of the toroid coils, with axes of symmetry in line, it is also possible to arrange even-numbered multiples of two toroid coils along the common axis of symmetry. Even if the toroids are arranged in a plane, the coil arrangement is not limited to two toroids. It is impossible to arrange a third toroid coil in the same plane, alongside the first two toroid coils, whereby the three coils would then be coupled via three control windings each of which encompass two of the toroid coils. Since this could mean a deterioration in the electrical properties in terms of power density and efficiency, it is more beneficial to couple an even number of toroid coils to each other.

In the embodiment in which the toroid coils are arranged coaxially one above the other, the windings of the control winding are preferably evenly distributed over the circumference of both toroid coils. This results in a particularly beneficial, even pre-magnetization of the core material.

Each of the toroid coils is preferably wound in a single layer with its working winding. This allows the copper losses caused by the high-frequency current to be kept low.

Each working winding can be formed from a single insulated wire, a group of parallel, non-twisted single insulated wires or from a litz wire consisting of twisted single insulated wires. If single wires are used, the diameter of the wire is preferably limited to a maximum of three times the skin effect penetration depth. To ensure minimum energy losses, i.e. copper losses, the effective copper cross-section of the windings should be as large as possible. Thus in terms of energy losses, the thickest possible wire should be chosen. However, when an AC current is employed, due to the skin effect, the area of the winding wire which is much further away than the skin effect penetration depth from the surface of the wire becomes largely ineffective. A winding wire which is thicker than three times the skin effect penetration depth would thus be unsuitable in terms of energy efficiency and material utilization.

The skin effect penetration depth 6 for copper wire at realistic working temperatures can be calculated approximately as follows:

$$δ [ mm ] \approx \frac{2 , 2}{\sqrt{f [ kHz ]}}$$

In accordance with the invention, each working winding is distributed as evenly as possible over the circumference of the respective toroid coil. As mentioned, the winding is preferably in a single layer. To minimize heat loss, the winding width of the toroid, which represents the inner toroid circumference, should be utilized as fully as possible. Should the working winding have a number of turns which will not cover the full winding width of the toroid, it is useful to divide the working winding into part windings and to connect these in parallel. This also ensures that the current flow will be distributed evenly over the core in order to thus suppress external magnetic interference fields.

In place of a single wire or parallel single wires, the working winding can also take the form of a twisted, high-frequency litz wire. For high-frequency litz wire, the diameter of the individual wires in the litz wire should be less than the single skin effect penetration depth.

The working windings of the two toroid coils can be connected in parallel or in series. In either case, the circuitry of the working winding should be chosen in such a way that when a current flows through the working windings, the directions of the magnetic fields created by them in the control coil should point in the opposite direction to each other so that no current is induced in the control winding by the working winding. Any interaction between the working windings and the control windings is thus impossible.

Any currents induced in the control winding stemming from the working windings can generate, ate interference in the control winding, and in power engineering applications they also cause additional unwanted heating in the control winding. At the same time, due to such interaction, energy is transferred from the working windings to the control winding which results in the quality of the coil arrangement being reduced. If there is no interaction between the control winding and the working winding, then no interference occurs in the working windings during flow changes through the control winding.

Combinations of series and parallel connections can also be provided.

The cores are preferably made of the same material so that at an appropriate pre-magnetization level all the cores react with the same effective permeability.

The invention is described in more detail below on the basis of preferred embodiments with reference to the drawings. The figures show:

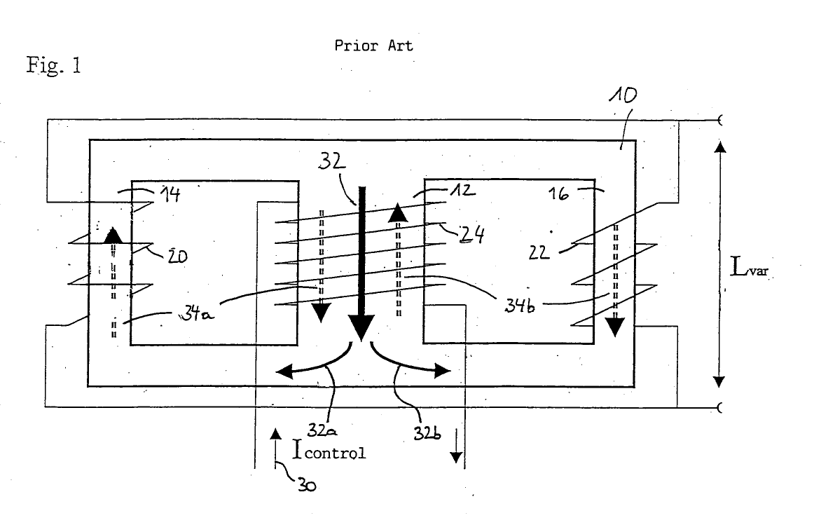

FIG. 1 a schematic view of the layout of a coil arrangement with variable inductance according to the prior art;

FIGS. 2A, 2B, 2C a view from above, a side view and a schematic perspective view of a coil arrangement with variable inductance in accordance with a first embodiment of the invention;

FIG. 3 a view from above of a coil arrangement with variable inductance in accordance with a second embodiment of the invention;

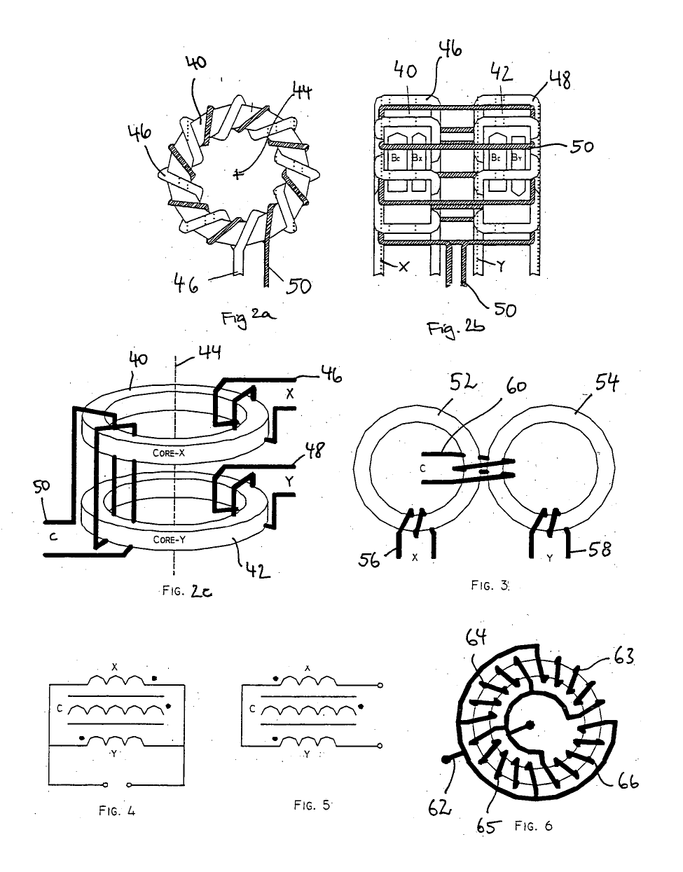

FIGS. 4 and 5 a schematic view of the circuitry of the windings of the coil arrangement presented in the invention connected in parallel and connected in series respectively; and

FIG. 6 a schematic view of the circuitry of a working winding of a toroid coil which is divided into several part windings.

FIG. 1 shows a coil arrangement with variable inductance according to the prior art consisting of an EE core 10 with a center leg 12 and two outer legs 14, 16. Each of the two outer legs carry a working winding 20, 22 which are connected in parallel to each other. The center leg 12 has a larger cross-section than the outer legs 14, 16 and carries a control winding 24. A control current 30, which essentially has no AC current portion, flows through the control winding 24. The control current generates a control flux 32 which, according to the magnetic coupling, is distributed 32a, b evenly across the two outer legs 14, 16, and there generates the pre-magnetization dependent on the control current 30. Due to the anti-symmetric winding direction of the outer working windings 20, 22, the two fluxes 34a,b generated in the outer legs produce opposite fluxes 34a,b of the same amount in the center leg 12 so that they are canceled out there. This means that there is no interaction between the outer working windings 20, 22 and the control winding 24. Due to the pre-magnetization generated in the outer working windings 20, 22 by the control winding 24, these outer working windings have a variable inductance Iᵥₐᵣ dependent on the control current 30.

FIGS. 2A and 2B show respectively a view from above and a side view of a coil arrangement with variable inductance in accordance with a first embodiment of the invention. The coil arrangement includes two toroids 40, 42 having the same dimensions which are arranged coaxially next to each other so that their axes of symmetry, schematically indicated in FIG. 2A by a cross 44, are in line with each other. The toroids 40, 42 preferably have a rectangular base cross-section which can be seen more readily in FIG. 2C. The toroids are made from a ferro or ferromagnetic material. Each toroid 40, 42 carries a working winding 46 or 48, of which only one, 46, can be seen in FIG. 2A. A control winding 50 is wound around both the wound toroid coils 40, 46 and 42, 48. The working windings 46, 48 are preferably wound in a single layer around their associated toroids 40, 42, whereby the winding width should be utilized as fully as possible. The control winding 50 is also evenly distributed around the circumference of both the toroids 40, 42 to achieve optimal guidance of the pre-magnetized field and homogeneous control of the core. This results in a maximum controllable inductance range. In addition, interference fields, which might be generated by fast changing control signals in the control coil 50, are suppressed towards the outside.

Depending on the application, the working windings 46, 48 can be connected electrically in parallel or in series. The winding direction of the working windings 40, 42, however, should be so chosen that for the magnetic fields Bx and By, which are generated by the windings 46, 48 through which the current flows, opposing magnetic field directions are established in the common control coil 50 of both toroids. In FIG. 2B, the magnetic field directions for the working winding 46 are marked with Bx, for the working winding 48 with By and for the control winding 50 with Bc. By using an appropriate circuitry for the working windings 46, 48, a feedback effect of the magnetic fields generated by the working windings on the control winding 50 can be minimized or even avoided. A control DC current is sent through the common control winding 50 which can change and in particular reduce the magnetic permeability of the toroids 40, 42 and thus the inductance of the working windings 46, 48. In practice, the working windings 46, 48 are operated using a high-frequency AC current.

In the illustration in FIG. 2B, both the toroid coils 40, 46 and 42, 48 are arranged with common rotational axes but at a distance from each other in order to illustrate the coil windings more clearly. In practice, however, the two coils can also be arranged close together next to each other. Whereas the working windings 46, 48 should be wound as far as possible evenly and densely in a single layer on core 40 or 42, the requireiments for winding the control coil 50 are less strict. Although its windings should also be distributed around the circumference of both coil cores 40, 42, the distribution need not be even. It is also not important if the winding is in a single or several layers.

The evenly wound coil geometry is inherently self-shielding and prevents magnetic stray fields from escaping from the cores 40, 42. EMC-related stray fields are thus prevented. A more even magnetization is also achieved compared to the arrangements in the prior art.

FIG. 2C only serves to explain the embodiments in FIGS. 2A and 2B, whereby the working windings 46, 48 and the control winding 50 are only depicted schematically in order to illustrate how the toroids 40, 42 and the windings 46, 48, 50 are arranged in relation to one an other. In practice, the working windings 46 and 48 as well as the control winding 50 are preferably distributed around the circumference of the toroids 40, 42, as explained above.

FIG. 3 schematically depicts another embodiment of the coil arrangement in accordance with the invention seen from above. In the embodiment shown in FIG. 3, the coil arrangement includes a first toroid 52 as well as a second toroid 54 each of which carry a working winding 56 or 58. The working windings 56, 58 should be wound evenly distributed around the circumference of the toroids 52 or 54. However, they are preferably wound in a single layer evenly around the full circumference of the toroids 52, 54, as illustrated in FIGS. 2A and 2B for the first embodiment. The two toroids 52, 56 and 54, 58 are arranged next to each other in one plane, whereby a control winding 60 is only wound around a narrow portion of the circumference of the two toroids 52, 54, where they touch each other. The advantage of the arrangement shown in FIG. 3 is found particularly in its flat design and the large surface which is advantageous for cooling the coil arrangement.

In FIGS. 2B and 2C, in FIG. 3 as well as in FIGS. 4 and 5, the working windings are also marked with X and Y, and the control winding is marked with C. The terminals of the working windings X and Y can be connected in parallel as shown in FIG. 4, or in series as shown in FIG. 5. FIGS. 4 and 5 also show the interaction between the working coils X, Y and the control coil C. An appropriate circuitry for working coils X and Y and choice of its winding direction ensures that the magnetic fields Bx and By generated by the working coils are aligned in such a way that they cancel each other out in their common control coil C, in order to prevent a feedback effect of the magnetic fields generated by the working windings from influencing the control winding.

As described above, the working windings 46, 48; 56, 58 should be distributed in one layer around the circumference of the toroids 40, 42 or 52, 54 in order to keep the copper losses caused by the high-frequency current that moves through the working winding as low as possible. The diameter of the wire is limited to a maximum of three times the skin effect penetration depth.

Moreover, to minimize heat loss, the winding width should be utilized as fully as possible. In other words, the winding space, i.e. the inner circumference of the toroid coils should be filled as much as possible with copper in order to achieve maximum efficiency. If the working windings 46, 48; 56, 58 do not have a sufficient number of turns, it is useful to divide these into part windings which are connected in parallel. FIG. 6 shows the division of a working winding 62 into four part windings 63, 64, 65, 66 which are connected in parallel.

For a given number of turns N (e.g. N=4), the number of part windings connected in parallel is determined by first determining a real number m from the inner toroid circumference Uᵢ and the skin effect penetration depth δ, whereby m is then rounded up to the nearest whole number M. Since the wire diameter is to be limited to three times the skin effect penetration depth, as mentioned above, a factor 3 is introduced to take this three times the skin effect penetration depth into account. Additionally, a factor 0.9 is also introduced which takes account of the fact that in the practical realization of a wound toroid coil the full winding width is not 100% available. This results in the following formula for the real number m:

$$m = \frac{0.9 \cdot {U}_{i}}{3 \cdot δ \cdot N}$$

Thus, depending on the number of turns N of the respective working winding, M part windings are preferably provided on each toroid and connected in parallel as depicted in FIG. 6.

The corresponding wire diameter d that should preferably be used, results as follows:

$$d = \frac{0.9 \cdot {U}_{i}}{N \cdot M}$$

In place of a single wire or several parallel single wires, twisted high-frequency litz wire can also be used for the working windings, whereby the diameter of the individual wires have to be adapted accordingly and are preferably smaller than the single skin effect penetration depth.

The characteristics revealed in the above description, the figures and the claims can be important for the realization of the invention its various embodiments both individually and in any combination whatsoever.

### IDENTIFICATION REFERENCE LIST

10 Core

12 Center leg

14, 16 Outer legs

20, 22 Coil windings

24 Control winding

30 Control current

32 Control flux

34a,b Fluxes

40, 42, 46, 48 Working windings

50 Control winding

52, 54 Toroid

56, 58 Working windings

60 Control winding

62 Working winding

63, 64, 65, 66 Part windings

1. A coil arrangement with variable inductance having two separate toroid coils (40, 42; 52, 54) which carry working windings (46, 48; 56, 58), and a control winding (50; 60) encompassing the two wound toroid coils for the purpose of pre-magnetizing the core material of the toroid coils (40, 42; 52, 54).

2. A coil arrangement according to claim 1, characterized in that the toroid coils (40, 42) are arranged next to each other in such a way that their axes of symmetry (44) are in line.

3. A coil arrangement according to claim 2, characterized in that the windings of the control winding (50) are distributed evenly over the circumference of the two toroid coils (40, 42).

4. A coil arrangement according to claim 1, characterized in that the two toroid coils (52, 54) are arranged adjacent to each other in a common plane.

5. A coil arrangement according to claim 1, characterized in that each of the toroid coils (40, 42; 52, 54) is wound with the working windings (46, 48; 56, 58) in a single layer.

6. A coil arrangement according to claim 1, characterized in that each working winding (46, 48; 56, 58) is formed from a single insulated wire, a group of parallel non-twisted insulated wires or from a litz wire consisting of twisted single insulated wires.

7. A coil arrangement according to claim 1, characterized in that each working winding (46, 48; 56, 58) is evenly distributed around the periphery of the respective toroid coil.

8. A coil arrangement according to claim 1, characterized in that the two toroids (40, 42; 52, 54) have identical dimensions and the two working windings (46, 48; 56, 58) have essentially the same number of turns and identical wire thicknesses.

9. A coil arrangement according to claim 1, characterized in that the working windings (46, 48; 56, 58) consist of a single wire or parallel non-twisted single wires, whereby, the single wire thickness is not greater than three times the skin effect penetration depth of the working frequency.

10. A coil arrangement according to claim 1, characterized in that the working windings (46, 48; 56, 58) are formed from a twisted litz wire with the diameter of the individual wires being not greater than the single skin effect penetration depth.

11. A coil arrangement according to claim 1, characterized in that the working windings (46, 48; 56, 58) are connected in parallel and the winding direction of the working windings (46, 48; 56, 58) is chosen such that when a current flows in the working windings, the directions of its magnetic fields in the control coil (50) point are opposite to each other.

12. A coil arrangement according to claim 1, characterized in that the working windings (46, 48; 56, 58) are connected in series and the winding direction of the working windings (46, 48; 56, 58) is so chosen that when a current flows in the working windings, the directions of its magnetic fields in the control coil (50) point in the opposite direction to each other.
